(19) United States
(12) Patent Application Publication
(10) Pub. No.: US 2012/0108484 A1
(43) Pub. Date: May 3, 2012

(54) CLEANING AGENT CONTAINING CARBAMIDE AND/OR AT LEAST A DERIVATIVE THEREOF

(75) Inventors: Klaus Becker, Hamburg (DE); Manfred Haake, Marburg-Cappel (DE)

(73) Assignee: BBT Bergedorfer Biotechnik GmbH, Hamburg (DE)

(21) Appl. No.: 13/256,140

(22) PCT Filed: Mar. 17, 2010
(86) PCT No.: PCT/EP2010/001682

§ 371 Date: Dec. 15, 2011

(30) Foreign Application Priority Data
Mar. 17, 2009 (EP) 09003835.7
Jun. 9, 2009 (EP) 09007638.1

(51) Int. Cl. C11D 3/60; C11D 17/00

(52) U.S. Cl. 510/138; 510/218; 510/501; 510/445; 510/405; 510/237; 510/276; 510/161

(57) ABSTRACT

The invention relates to the use of an agent that contains 5 to 99.9% by weight of carbamide and/or at least a derivative thereof, as a cleaning agent e.g. for closed systems, in particular as a dishwasher detergent, as a laundry detergent for washing machines, as an agent for cleaning, sanitizing and/or disinfecting for equipment in the food processing industry and for medical equipment, the use as a hand dishwashing detergent or sanitary cleaner or as a hand cleaner.

The invention relates to a cleaning agent whose weight contains 5 to 99.9% by weight carbamide and/or one or more derivatives thereof, especially as a cleaning agent for closed systems, in particular as a dishwasher detergent, as a laundry detergent for washing machines (especially for cleaning of textiles), as an agent for cleaning, sanitizing and/or disinfecting equipment in the food processing industry and for medical equipment, as a hand dishwashing detergent or sanitary cleaning agent or as a hand cleaner (for washing hands).

According to the invention, closed systems refers to devices that are either fully closed off to their surroundings during operation, for example dishwashers, washing machines or the like, or are hermetically closed off from the surroundings prior to their operation and are opened only upon start-up, for example equipment for food processing or also medical equipment such as rinsing devices for operating rooms and dentist chairs, dialysis equipment, cardiopulmonary machines, endoscopes and similar medical equipment. While in the first-mentioned systems the cleaning agent circulates in the equipment during operation, in the latter-named systems, the system is rinsed with the cleaning agent. Here, the cleaning agent not only serves for cleaning purposes but is also used for sanitizing and/or potentially for disinfecting.

Cleaning agents for closed systems such as dishwasher detergents, laundry detergents for washing machines, hand dishwashing detergents and sanitary cleaning agents are agents that are used in almost every household. Modern dishwashing detergents such as the ones described in WO 2007/141257 typically contain surfactants, detergent builders, bleaching agents and enzymes as significant components.

Enzymes are molecules, in particular proteins which are able to catalyze a certain chemical reaction. Enzymes play an important role in the metabolism of all living organisms; they catalyze and control many biochemical reactions, e.g., during copying (DNA polymerase) or transcribing (RNA polymerase) the genetic information. Enzymes used in dishwasher detergents are, for example, proteases, amylases, catalases, peroxidases, cellulases and/or lipases. Preferred is the use of proteases and amylases.

Enzymes are relatively expensive compared to the other components of a modern cleaning agent for closed systems, dishwashing detergents or sanitary cleaners. Despite the use of expensive enzymes, the cleaning effect of modern cleaning agents such as dishwashing detergents is often only satisfactory. In addition, the use of enzymes is often accompanied by disadvantages; for example the dishwashing detergents can be used only within a certain temperature and pH-value range, and stability problems can occur, in particular with longer storage. Finally, it is problematic when considering environmental viewpoints if uncontrolled amounts of enzymes enter the waste water. Furthermore, handling enzymes during manufacturing or use of enzyme-containing products is not unproblematic (e.g., allergy potential).

It was, therefore, the objective of the invention to reduce the aforementioned disadvantages.

It was, in particular, the objective of the invention to provide a cleaning agent e.g. for closed systems, a hand dishwashing detergent or a sanitary cleaning agent that exhibits a high cleaning effect. Despite the high cleaning effect, the cleaning agent or the dishwashing detergent, respectively, or the sanitary cleaning agent shall be surface-friendly. In addition, its use shall be possible over a wide pH-value range (neutral, alkaline, acidic).

In the case of a dishwashing detergent, it was a further objective of the invention to provide an agent that can be used over a broad temperature range, in particular from 15° C. to 70° C. or 15° C. to 80° C., and that achieves an advantageous cleaning effect over as wide a temperature range as possible. It should be possible to use it for both household dishwashers as well as commercial dishwashers. Furthermore, the cleaning agent should provide glass-friendly cleaning.

Carbamide (urea) is a neutral, odorless, non-toxic product with very good water solubility that is eliminated by the human organism as an end product of the nitrogen metabolism in amounts of 20 to 30 g per day and which is regarded as one of the most environmentally friendly substances in nature. There, it can be broken down into its components through chemical decomposition, or it can be stored in the form of water-soluble or non-soluble salts (e.g., as Ca carbonate and/or Mg carbonate).

Under this aspect, carbamide—which can be regarded as a diamide of carbonic acid—can be viewed as the bound form of the two gaseous components NH₃ and CO₂ (at a ratio of 2:1), from which it can be manufactured commercially on a huge scale due to its use in the areas of fertilizers and synthetic resins.

Through the inventive use of carbamide in cleaning agents a significant contribution is made to environmental protection through the increased use of carbamide in the cleaning sector through the binding of CO₂ gas during the technical production, the use as a cleaning agent and the disposal in nature as harmless salts (in particular carbonates and hydrogen carbonates).

Further, for environmental and cost reasons it shall be made possible to reduce the amount of enzymes and bleaching reagents that are typically used in conventional cleaning agents.

Preferably only biodegradable and/or bio-reclaimable substances shall be used, in particular those being biodegradable according to EN ISO 14593: 199 (CO₂ headspace test).

Unexpectedly, the objectives of the current invention could be solved by providing a cleaning agent having a high carbamide (urea) content.

Furthermore the objectives of the present invention could be solved by using carbamide (urea) as cleaning agent.

The present invention relates to a cleaning agent containing 5 to 99.9% by weight of carbamide and/or one or more derivatives thereof, which can be used as a cleaning agent e.g. for closed systems, in particular as a dishwasher detergent, as a laundry detergent for washing machines, as an agent for cleaning, sanitizing and/or disinfecting for equipment in the food processing industry or for medical equipment, as a hand dishwashing detergent or as a sanitary cleaning agent, in particular a sanitary toilet cleaning agent.

In particular, the present invention relates to a cleaning agent, comprising:

(a) 5 to 99.9% by weight of carbamide and/or one or more derivatives thereof;
(b) 0.1 to 90% by weight of one or more electrolyte(s);
(c) up to 40% by weight of one or more surfactant(s);
(d) up to 10% by weight of one or more enzyme(s); and
(e) up to 20% by weight of one or more complexing agent(s).

Furthermore, the present invention provides a method for reducing or avoiding enzymes in cleaning agents e.g. for closed systems, in particular in dishwasher detergents, in laundry detergents for washing machines, in agents for cleaning, sanitizing and/or disinfecting equipment in the food processing industry or for medical equipment, in hand dishwashing detergents or in sanitary cleaning agents, characterized in that in an enzyme-containing cleaning agent, in an enzyme-containing laundry detergent or in an enzyme-containing sanitary cleaning agent a certain amount of enzymes is replaced by 5 to 50 times the amount of carbamide and/or one or more derivatives thereof.

With regard to the use of the agent as a sanitary cleaning agent it should be mentioned that the sanitary cleaning agent remains on the surface to be cleaned only during the actual cleaning process, for example on the ceramic surface of a toilet, and is fully rinsed off after cleaning is completed such that the generation of odors occurring e.g. during possible degradation of the carbamide is prevented.

Preferably the cleaning agents according to the present invention are used as dishwashing detergents (especially for a dishwasher). These cleaning agents may be in solid or liquid form. Preferably the cleaning agents are in solid form, especially in form of a powder, granules or tablets (dishwasher tablets or tabs).

Furthermore preferably the cleaning agents according to the present invention are used as sanitary cleaning agent (especially as toilet cleaner). These cleaning agents may be in solid (e.g. as powder or granules) or liquid (e.g. as a gel) form. Preferably the cleaning agents are in solid form, especially in form of a powder.

The explanations/definitions given below relate to the cleaning agents according to the present invention e.g. for closed systems (in particular to agents for cleaning, sanitizing and/or disinfecting), the inventive dishwashing detergents and the inventive sanitary cleaning agents—unless otherwise stated. To improve clarity, reference will be made to “agent according to the invention” or “cleaning agent according to the invention”.

The agent according to the invention contain 5 to 99.9% by weight, preferably 10 to 95% by weight, more preferred 10 to 90% by weight (e.g. 10 to 70% by weight), even more preferred 20 to 80% by weight, in particular preferred 25 to 75% by weight, very particularly preferred 20 to 70% by weight and especially 20 to 60% by weight carbamide (urea) and/or one or more derivatives thereof, relative to the total weight of the agent.

Dishwashing detergents preferably contain 15 to 65% by weight, especially for powdered dishwashing detergents 30 to 60% by weight of carbamide.

Sanitary cleaners preferably contain 10 to 40% by weight, especially 10 to 30% by weight of carbamide.

In contrast to these high amounts, carbamide has been used in dishwashing detergents and sanitary cleaning agents of the prior art only as an additive in marginal amounts. For example, DE 199 23 943 A1 discloses a sanitary cleaning agent in which carbamide was used as a germ-promoting organic substance in an amount of about 0.5% by weight. However, in this case carbamide was not used for improving the cleaning effect and for solving the aforementioned objectives.

Carbamide (also known as urea) has the chemical structure of formula (I):

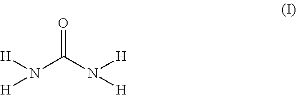

The present invention furthermore relates to derivatives of carbamide. Preferred derivatives are compounds of formula (II),

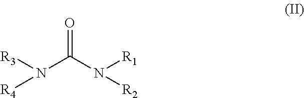

wherein R₁, R₂, R₃ and R₄ independently from each other have the following meaning: a hydrogen atom, an alkyl group having 1 to 4 carbon atoms, a cycloalkyl group having 3 to 6 carbon atoms, an aryl group like phenyl or naphthyl, an arylalkyl (aralkyl) group having 7 to 18 carbon atoms, an alkylaryl group having 7 to 18 carbon atoms or an O-, S-, or N-containing heterocyclic group having 2 to 5 carbon atoms.

Moreover, two of the residues R₁, R₂, R₃ and R₄ together may form part of a heterocyclic group having 1 to 8 (especially 2 to 5) carbon atoms and one or more further heteroatom(s) (in addition to the nitrogen atom(s) to which the residues R₁, R₂, R₃ and R₄ are respectively bound) selected from O, S and N, i.e. carbamide derivatives of formulas (IIa), (IIb) (IIc), and (IId):

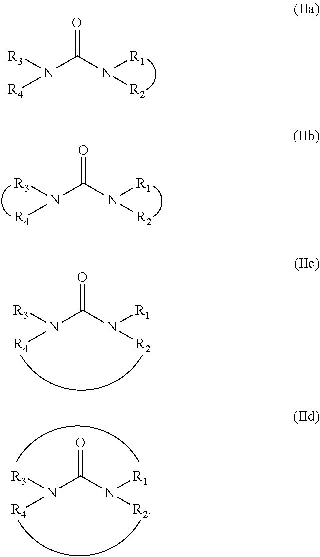

In particular the methyl, ethyl, n-propyl, i-propyl as well as the various isomers of the butyl group are examples for an alkyl group having 1 to 4 carbon atoms. Examples for the cycloalkyl group having 3 to 6 carbon atoms are in particular the cyclopropyl, cyclobutyl, cyclopentyl as well as the cyclohexyl group. Examples for an aralkyl group having 7 to 18 carbon atoms are in particular the benzyl and phenethyl group, examples for a alkylaryl group having 7 to 18 carbon atoms are in particular the tolyl group and examples for a heterocyclic group having 1 to 8 (especially 2 to 5) carbon atoms are in particular those having at least oxygen, sulfur or nitrogen atom in the heterocyclic ring. Here the radicals of oxirane, tetrahydrofuran, dioxane as well as pyran can be named as suitable examples.

The term “derivatives” also includes dimers and trimers of the compounds of the formulas (I) and (IIa-d).

In one embodiment, the carbamide dimer (biuret) according to formula (III) is used as a derivative:

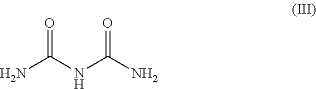

Furthermore, the term “derivative” also includes salts, solvates, hydrates and other adducts of the compounds mentioned above under formulas (I) to (III). These include e.g. carbamide sulfate, carbamide phosphate and carbamide hydrogenperoxide (Percarbamide).

Finally, it is also possible to use carbamide derivative mixtures or mixtures of carbamide and carbamide derivatives.

Especially preferred is the use of carbamide (urea) in the cleaning agent according to the present invention.

According to the invention, the agent of the invention can be used as a cleaning agent for closed systems such as dishwashers or washing machines, as an agent for cleaning, sanitizing and/or disinfecting of equipment in the food industry and of medical equipment, as dishwashing detergent or as a sanitary cleaning agent.

The cleaning agent according to the invention can e.g. be used for closed systems. With appropriate dosing of the carbamide, it can also be used as an agent for cleaning, sanitizing and/or disinfecting of equipment in the food industry and of medical equipment.

In general, dishwashing detergents are used as agents for cleaning dishes. The agent according to the invention can be used both as a dishwasher detergent and as a hand dishwashing detergent. Its preferred use is as a dishwasher detergent, in particular for both commercial dishwashers and household dishwashers.

In general, sanitary cleaning agents are used for cleaning sanitary surfaces. The preferred use of the agent according to the invention is the cleaning of toilet bowls or urinals. Thus, preferably the sanitary cleaning agent is a toilet cleaning agent.

In addition to carbamide and/or derivatives thereof, the agent according to the invention may contain one or more surfactants such as anionic, nonionic, cationic and/or amphoteric surfactants. Also any mixtures of the surfactants explained below are possible.

The agent according to the present invention may contain up to 40% by weight, preferably 0.01 to 40° A) by weight, more preferably 0.1 to 35% by weight, moreover preferred 0.5 to 30% by weight, particularly preferred 1 to 30% by weight of one or more surfactants, relative to the total weight of the agent.

In general, anionic surfactants refer to surfactants having a negatively charged functional group. Typically, anionic surfactants possess polar and non-polar portions. Preferably a C₆-C₃₀-alkyl residue serves as the non-polar portion. The polar functional group is preferably —COO⁻ (carboxylate), —SO₃⁻ (sulfonate) or —O—SO₃⁻ (Sulfate).

Examples are:

Alkyl carboxylates of formula R—COO⁻Na⁺, where R is an organic residue having 6 to 30, preferably 8 to 16 carbon atoms;
Alkyl benzenesulfonates (ABS) of formula CₙH₂ₙ₊₁—C₆H₄—SO₃⁻Na⁺, where n is 6 to 30, preferably 8 to 16, (e.g., sodium dodecylbenzenesulfonate);
Secondary alkanesulfonates (SAS) of formula CₙH₂ₙ₊₁—SO₃⁻Na⁺, where n is 6 to 30, preferably 8 to 16; and
Fatty alcohol sulfates (FAS) of formula H₃C—(CH₂)ₙ—CH₂—O—SO₃⁻Na⁺, where n is 6 to 30, preferably 8 to 16 (for example sodium laurylsulfate).

Preferably, C₉₋₁₅-alkyl benzenesulfonates and olefinsulfonates are used as sulfonate-type surfactants. Also suitable are alkane sulfonates that are obtained from C₁₂₋₂₀-alkanes for example by sulfochlorination or sulfoxidation with subsequent hydrolysis or neutralization. Also suitable are esters of α-sulfo-fatty acids (ester sulfonates), e.g., α-sulfonated methyl esters of hydrated coconut, palm kernel or tallow fatty acids. One specific example is Ufaryl (e.g. Ufaryl DL 90 C), an alkyl benzenesulfonate.

Additional suitable anion surfactants are sulfonated fatty acid glycerin esters. Fatty acid glycerin esters refer to monoesters, diesters and triesters as well as their mixtures. Preferred sulfonated fatty acid glycerin esters are sulfonated products of saturated fatty acids with 6 to 22 carbon atoms, for example of the caproic acid, caprylic acid, myristic acid, palmitic acid, stearic acid or behenic acid.

An additional class of anion surfactants is the class of ether carboxylic acids accessible through the conversion of fatty alcohol ethoxylates with sodium chloroacetate in the presence of alkaline catalysts. Further suitable anionic surfactants are partial esters of di- or polyhydroxy alkanes, mono- and disaccharides, polyethylene glycols with en-adducts of maleic acid anhydride to at least mono-unsaturated carbonic acids with a chain length of 10 to 25 carbon atoms and preferred with an acid number of 15 to 130. Alternatively usable anionic surfactants are sulfosuccinates, sulfosuccinamates and sulfosuccinamides, in particular sulfosuccinates and sulfosuccinamates, and particularly preferred sulfosuccinates.

Generally, nonionic surfactants refer to surfactants that essentially contain no dissociable functional groups and, therefore, do not dissociate into ions when placed in water. Like all surfactants, nonionic surfactants are also made up of a non-polar and a polar component/portion. As non-polar portion, the nonionic surfactants preferrably contain a fatty alcohol (e.g., C₁₂-C₁₈) or e.g., an octyl or nonyl phenol residue. As the polar portion, the nonionic surfactants preferrably contain hydroxyl groups or ether groups.

Examples for nonionic surfactants are:

Polyalkylene glycol ether;
Fatty alcohol ethoxylates (FAEO), in particular of formula CH₃—(CH₂)₁₀₋₁₆—(O—C₂H₄)₁₋₂₅—OH;
Fatty alcohol propoxylates (FAPO), in particular of formula CH₃—(CH₂)₁₀₋₁₆—(O—C₃H₆)₁₋₂₅—OH
Alkyl glucosides;
Alkyl polyglucosides (APG), in particular of formula CH₃—(CH₂)₁₀₋₁₆—(O-glycoside)₁₋₃-OH;
Oktyl phenolethoxylates, in particular of formula C₈H₁₇—(C₆H₄)—(O—C₂H₄)₁₋₂₅—OH; and/or
Nonylphenol ethoxylates, in particular of formula C₉H₁₉—(C₆H₄)—(O—C₂H₄)₁₋₂₅—OH.

Cationic surfactants refer to surfactants that include a positively charged functional group. Preferably, these are quaternary ammonium compounds of the formula R₁ₐR₂ₐR₃ₐR₄ₐN⁺X⁻, wherein R₁ₐ to R₄ₐ are independently organic residues having 4 to 20 carbon atoms, preferably stearyl, palmityl, methyl, benzyl, butyl residues, and wherein X is a gegenion (counterion), preferably a halide.

Amphoteric surfactants refer to surfactants that include both a negatively and a positively charged functional group. Preferably an alkyl group serves as the non-polar portion, and a carboxylate group (R—COO⁻) and a quaternary ammonium group as the polar portion.

In the case of dishwashing detergents, a preferred embodiment uses, in particular, polyoxyethylene sorbitan fatty acid esters (e.g., obtainable as Span® or Tween® 80) and/or a C₁₂-C₁₄ alcohol polyethylene glycol ether (obtainable as Marlox® MO 154, for example) as surfactants. This demonstrates an advantageous stability in liquid dishwashing detergents.

Further preferred surfactants are nonionic low-foaming or solid surfactants which are e.g. sold under the trademarks Genapol (e.g. Genapol EP 2584), Lutensol (e.g. Lutensol AT 25) and Plurafac (e.g. Plurafac LF 901) and belong to the class of alkyl polyglycol ethers and fatty alcohol ethoxylates, respectively.

In one preferred embodiment, the agent according to the invention contains up to 20% by weight, preferrably 0.01 to 20% by weight, more preferably 0.5 to 20% by weight, even more preferred 0.5 to 15% by weight, particularly preferred 0.2 to 15% by weight of one or more complexing agents, relative to the total weight of the agent.

Complexing agents are ligands that exhibit two or more binding sites. Thereby they are able to form particularly stable complexes with polyvalent metal ions. Examples for complexing agents are nitrilo triacetate (NTA), ethylene diaminotriacetate (TED), ethylene diamine tetraacetate (EDTA), methylglycine diacetate (MGDA) (e.g. Trilon M)), oxalate, maleate, tartrate and/or citrate, especially preferred are the sodium salts thereof. Also in case citrate/citric acid is/are used as electrolytes (and/or pH adjusters), it is preferred that the above named complexing agents are present in the amounts given.

Further examples for complexing agents are polyacrylic acids and salts thereof (e.g. Sokalan PA 30 CL, a low molecular weight polyacrylic acid, fully neutralized as the sodium salt) as well as the natural polysaccaride alginate and salts thereof.

Most of such complexing agents are often summarized in detergent cleaners together with other electrolyte type additives under the general term “builders”.

Frequently these are water-soluble substances or non-water-soluble substances such as aluminosilicates and in particular zeolites may be used as builders.

Zeolites which are suitable as builders include, for example, zeolite A, zeolite X, zeolite Y and zeolite P.

Other suitable builders are, for example, polyacetales, which can be obtained by converting dialdehydes using polyolcarboxylic acids that preferably exhibit 5 to 7 C atoms and at least 3 hydroxyl groups. Preferred polyacetales are obtained from dialdehydes such as glyoxal, glutaraldehyde, terephthalaldehyde as well as mixtures thereof and of polyolcarboxylic acids such as gluconic acid and/or glucoheptonic acid.

Further suitable organic builders are dextrins, i.e., oligomers or polymers of carbohydrates that can be obtained through the partial hydrolysis of starches. In addition, polyacrylates, pectinates and alginates can be used as builders which are also considered to be “complexing agents” in the context of the present invention.

As an alternative, phosphate based builders may also be used. However, for environmental reasons these are not preferred. Examples are sodium tripolyphosphates, sodium pyrophosphate and sodium orthophosphate. Phosphonates which may also be considered as suitable builders or complexing agents are solely mentioned as one specific example which is sold under the trademark Bayhibit (e.g. Bayhibit S). Preferably, the cleaning agent according to the invention is phosphate-free or contains only small amounts (e.g. up to 0.19% by weight of phosphonate).

The aforementioned complexing agents as well as the following electrolyte type agents can be considered as suitable builders which are able to support the observed cleaning efficiency of carbamide.

In one preferred embodiment, the agent according to the invention also includes one or more stabilizers. Here, solubilizing and/or dispersion-promoting components typically serve as the stabilizers. Preferably, polyalcohols are used as stabilizers. Polyalcohol refers to substances that include two or more alcohol groups. Examples for suitable stabilizers are glycol, propylene glycol, polyalkylene glycol, in particular polyethylene glycol (e.g., Pluriol®), polypropylene glycol, glycerol, sorbitol, mannitol or mixtures thereof.

The agent according to the invention may additionally contain one or more stabilizers in amounts of 0.01 to 20% by weight, preferably of 0.1 to 5% by weight, in particular if the agent according to the invention is present in liquid form.

In a further preferred embodiment, the cleaning agent according to the invention may further contain one or more antibacterial and/or antimycotic and/or antimicrobial additive(s), in particular in the case of a liquid preparation.

The antibacterial and/or antimycotic and/or antimicrobial additive(s) is/are typically included in an amount of 0.01 to 5% by weight, preferably of 0.1 to 2% by weight. For example, food chemistry approved preserving agents such as sodium formiate, sodium sorbate or PHB ester as well as suitable additives with an antimicrobial effect spectrum.

In the case of a hand dishwashing detergent or of a hand cleaning agent, i.e. a cleaning agent such as a washing paste for cleaning the skin surface, in particular the hand, it is also preferred that the agent according to the invention additionally includes one or more skin care components. These are typically included in an amount of 0.1 to 5% by weight, preferable of 1 to 3% by weight. Suitable as skin care components are, for example, amino acids or fruit acids. Preferred is the use of proline.

The cleaning agent of the present invention may contain enzymes. These enzymes are typically included in an amount of up to 10% by weight (e.g. 0.01 to 10% by weight), preferably up to 5% by weight (e.g. 0.01 to 5% by weight, especially 1 to 5% by weight), more preferably 0.1 to 3% by weight, especially 0.5 to 2.5% by weight, relative to the total weight of the agent.

Examples for suitable enzymes are proteases, lipases, amylases and cellulases. Specific examples are commercially available coated enzyme preparations in solid form, e.g. Savinase 6.0 T, Lipolase 100 T and Termamyl 120 T.

Further examples of enzymes include:
Proteases like BLAP® 140 (Company: Henkel); Optimase®-M-440, Optimase®-M-330, Optidean®-M-375, Opticlean®-M-250 (Company: Solvay Enzymes); Maxacal® CX 450.000, Maxapem® (Company: Ibis); Savinase® 4.0 T, 6.0 T, 8.0 T (Company: Novo); Esperase® T (Company: Ibis).
Amylases like Termamyl® 60 T, 90 T, Duramyl® (Company: Novo); Amylase-LT® (Company: Solvay Enzymes); Purafect OxAm® (Company: Genencor); Maxamyl® P 5000, CXT 5000 or CXT 2900 (Company: Ibis); especially α-Amylases like Termamyl®, Termamyl®ultra, Duramyl® (Company: Novozymes); Purastar®ST , Purastar®OxAm (Company: Genencor); Keistase® (Company: Daiwa Seiko).
Lipases like Lipolase® 30 T (Company: Novo).

In addition to the aforementioned components, the agent according to the invention can also include one or more odorous substances. Odorous substances are natural or synthetic substances that have an odor, preferably a pleasant odor. Examples for odorous substances are:

Ambrettolide, [alpha]-amylzimtaldehyde, anethole, anisaldehyde, anisalcohol, anisol, anthranilic acid methyl ester, acetophenone, benzyl acetone, benzaldehyde, benzo acid ethyl ester, benzophenone, benzyl alcohol, borneol, bornyl acetate, [alpha]-bromstyrol, n-decylaldehyde, n-dodecylaldehyde, eugenol, eugenol methyl ether, eucalyptol, farnesol, fenchone, fenchyl acetate, geranyl acetate, geranyl formiate, heliotropin, heptin carbonic acid methyl ester, heptaldehyde, hydrochinon-di-methylether, hydroxyzimtaldehyde, hydroxyzimt-alcohol, indole, iron, isoeugenol, isoeugenol methylether, isosafrol, jasmine, camphor, carvacrol, carvone, p-cresol methylether, cumarin, p-methoxy-acetophenone, methyl-n-amylketone, methyl anthranilic acid methylester, p-methyl acetophenone, methylchavicol, p-methyl quinoline, methyl-ss-naphthylketone, methyl-n-nonyl acetaldehyde, methyl-n-nonylketone, muscone, ss-naphthol-ethylether, ss-naphthol-methylether, nerol, nitrobenzene, n-nonylaldehyde, nonylalcohol, n-octylaldehyde, p-oxyacetophenone, pentadecanolide, ss-phenylethylalcohol, phenylacetaldehyde-dimethylacetal, phenyl acetic acid, pulegone, safrol, salicylic acid isoamylester, salicylic acid methylester, salicylic acid hexylester, salicylic acid cyclohexylester, santalol, skatol, terpineol, thyme, thymol, [gamma]-undelactone, vanillin, veratrumaldehyde, zimtaldehyde, zimtalcohol, cinnamic acid, cinnamic acid ethylester, cinnamic acid benzylester, alkyisothiocyanate (alkyl mustard oil), butandion, lime, linalool, linayl acetate and propionate, menthol, menthone, methyl-n-heptenone, phellandrene, phenylacetaldehyde, terpinyl acetate, citral and/or citronellal.

It is also possible to add one or more essential oils such as angelica root oil, anise oil, arnica blossom oil, basil oil, bay oil, champaca blossom oil, silver fir oil, silver fir cone oil, elemi oil, eucalyptus oil, fennel oil, spruce needle oil, galbanum oil, geranium oil, ginger grass oil, guaiacum oil, gurjun balsam oil, helichrysum oil, ho oil, ginger oil, iris oil, cajeput oil, calmus oil, chamomile oil, camphor oil, canaga oil, cardamom oil, cassia oil, pine needle oil, kopa[iota]vabalsam oil, coriander oil, crisped mint oil, caraway oil, cumin oil, lemon grass oil, musk grain oil, myrrh oil, clove oil, neroli oil, niaouli oil, olibanum oil, oregano oil, palmarosa oil, patchouli oil, peru balsam oil, petit grain oil, pepper oil, peppermint oil, pimento oil, pine oil, rose oil, rosemary oil, sandalwood oil, celery oil, star anise oil, thuja oil, thyme oil, verbena oil, vetiver oil, juniper berry oil, absinthe oil, winter green oil, ylang ylang oil, hyssop oil, cinnamon oil, cinnamon leaf oil and/or cypress oil.

Particularly preferred odorous substances are lime terpenes and/or orange terpenes.

Odorous substances are typically included in an amount of 0.01 to 3% by weight, preferably 0.01 to 2% by weight, relative to the total weight of the agent. If desired, a combination of 2 or more odorous substances, e.g., 2 to 10 can be used. A combination of odorous substances can be advantageous to cover potentially occurring urea odors.

In addition to odorous substances, the agent according to the invention can also include colorants (e.g. kiwi fruit green or TAED green).

If the cleaning agent of the present invention is in liquid form, it may contain water and/or one or more nonaqueous solvents.

Suitable nonaqueous solvents are, for example, selected from the group of one- or polyvalent alcohols, alkanolamines or glykolethers, as long as they mix with water. Preferably, the solvents are selected from ethanol, n- or i-propanol, butanols, glycol, propane or butandiol, glycerol, diglycol, propyl or butyldiglycol, hexylenglycol, ethylenglycol methylether, ethylenglycol ethylether, ethylenglycol propylether, ethylenglycol mono-n-butylether, diethylenglycol methylether, diethylenglycol-ethylether, Propylenglycol methyl, ethyl or propylether, dipropylenglycol-monomethyl or ethylether, di-isopropylenglycol monomethyl or ethylether, methoxy-, ethoxy- or butoxy-triglycol, 1-butoxyethoxy-2-propanol, 3-methyl-3-methoxybutanol, propylen-glycol-t-butylether as well as mixtures of these solvents. Nonaqueous solvents can be used in the liquid dishwashing detergents or sanitary cleaning agents typically in amounts of 0.1 to 90% by weight, preferably of 1 to 60% by weight, relative to the total weight.

In a further preferred embodiment, the agent of the present invention is a solid agent that is present in particulate form or in the form of pressed tabs or tablets. The agent according to the invention contains 0.1 to 90% by weight, more preferably 1 to 70% by weight (e.g. 5 to 70% by weight), even more preferred 5 to 60% by weight of electrolytes, relative to the total weight of the agent.

Depending on powder or liquid form, the dishwashing detergents preferably contain 5 to 60% by weight of electrolytes.

Sanitary cleaners preferably contain 5 to 90% of electrolytes.

Salts such as sodium sulfate or sodium chloride influence physicochemical parameters, e.g. the ionic strength, which can be advantageous for the cleaning activity of the agent to be used according to the ability in breaking inter- and intramolecular bonding (e.g. in proteins and carbohydrates).

Preferably the electrolytes are alkali or earth alkali salts, more preferrably alkali salts, especially sodium salts. Examples are sodium sulfate or sodium chloride, sodium bicarbonate, sodium carbonate, tri sodium citrate, sodium phosphate, sodium phosphonate, sodium acetate, sodium alginate, sodium maleate, etc. According to complexing and/or pH-adjusting ability of the anions, preferably tri sodium citrate and sodium carbonate are used in addition to pH adjusting buffer systems (e.g. citric acid/sodium hydroxide and/or sodium carbonate/sodium bicarbonate). Therefore, in one preferred embodiment, at least part of the electrolytes may be one or more substances which are able to adjust the pH value (pH adjuster). Such a pH adjuster is used for adjusting a suitable pH value of the cleaning agent (or if it is an agent in solid form, to adjust the pH value of a 1-molar solution of the agent in water).

Preferably, a pH value of 7 to 12, in particular of 8 to 11 is set for dishwashing detergents.

In this case the pH adjuster is preferably an alkaline agent. Preferably, the alkaline agent is available in the form of a basic alkali salt and/or earth alkali salt and/or an alkali and/or earth alkali hydroxide. In these compounds, sodium is preferred as the alkali metal. It is particularly preferred if the alkaline effective agent contains a mixture of sodium hydrogen carbonate (sodium bicarbonate) and sodium carbonate. Particularly advantageous results are achieved when the mixture of sodium carbonate and sodium hydrogen carbonate (sodium bicarbonate) is mixed such that about 2 to 4, in particular 2.8 to 3.3 parts by weight of sodium hydrogen carbonate (sodium bicarbonate) are added to two parts by weight of sodium carbonate. This mixture is then able to adjust the pH range to about 8 to 11, in particular to about 9 to 10.

Preferably, an acidic pH value of 1 to 6, in particular of 2 to 4 is set for sanitary cleaning agents for dissolving calcifications.

In this case the pH adjuster is preferably an acidifying agent. Preferably, both inorganic and organic water-soluble free acids, as well as their anhydrides and their acidic salts are used. Aside from sodium or potassium hydrogen sulfate and/or carbamide phosphate, in particular organic α-hydroxy carbonic acids (fruit acids) such as citric acid, tartaric acid, etc., for example, and or their anhydride can be used advantageously. These are also preferably applied in mixtures with amidosulfonic acid (e.g. citric acid and amidosulfonic acid in ratio of 3 to 1).

It is also possible that an increased viscosity of the agent according to the invention is desirable. For example, the agent according to the invention may be present as a gel. In this case, water or an organic liquid, e.g., alcohol, is used as a filler and additionally a thickener is added.

The viscosity of the agent according to the invention can be determined using common standard methods (for example, Brookfield Viskosimeter RVD-VII at 20 rpm and 20° C., spindle 3). Preferred liquid gel-like agents can exhibit viscosities of between 20 and 4000 mPa, with values between 40 and 2000 mPa being preferred.

Suitable thickeners are inorganic or polymeric organic compounds. Mixtures of different thickeners can be used as well.

Among the inorganic thickeners are, for example, poly silicic acids, clay minerals such as montmorillonites, zeolithes, silicic acids, layered silicates and bentonite. The organic thickeners come from the groups of natural polymers, the modified natural polymers and the fully synthetic polymers. Polymers stemming from nature that are used as thickeners are, for example, xanthan, agar-agar, carrageen, tragacanth, gum arabic, alginates, pectins, polyoses, guar gum, gellan gum, carob tree gum, starch, dextrins, gelatins and casein. In the case of liquid toilet cleaning agents, preferably xanthan is used as a thickener. In the case of liquid dishwashing detergents, preferably alginate, in particular sodiumalginate, is used as a thickener.

Modified natural substances come primarily from the group of modified starches and celluloses; carboxy methyl cellulose, hydroxy ethyl cellulose and hydroxy propyl cellulose as well as methyl hydroxy ethyl cellulose shall be named as examples.

If the agent is present in solid particulate form, the mean particle size by volume (D50) is preferably 50 to 800 μm, more preferred 100 to 600 μm, especially 150 to 450 μm. The particle size is determined in the manner described above. It is also preferred that the agent according to the invention in its particulate form exhibits a “Hausner factor” of 1.03 to 1.3, more preferred of 1.04 to 1.20 and especially of 1.04 to 1.15. The “Hausner factor” refers to the ratio of the compacted density to the bulk density. A respective particle size and a respective Hausner factor lead, for example, to an advantageous dissolution behavior and correspondingly to a better cleaning result. (Information on the “Hausner factor” can e.g. be found in: “Arzneiformenlehre II, Arbeitsanleitung zum Praktikum; Pharmazeutische Technologie”, Eberhard Karls Universität, Tübingen, Germany).

The information above indicates the potential components of the agent according to the invention. Basically, the individual components can be used in any combination within the scope of the stated proportions and on a broad base can lead to the development of effective cleaning agents. Especially preferably, the preferred ranges for one component may be combined with the preferred ranges of any other component. Exemplary, more detailed examinations were performed for the three areas of application, dishwasher detergents, hand dishwashing detergent and sanitary toilet cleaning agents, which achieved surprisingly good cleaning results. These shall be described below both in general and using specific examples with test results.

According to the present invention, the use of carbamide (urea) alone (100%) exhibits a surprisingly good cleaning performance and brightness of the glasses and dishes.

The cleaning efficiency of carbamide is significantly increased by the addition of electrolytes. Especially the use of neutral salts like sodium sulfate and/or sodium chloride or the use of tri sodium citrate and/or the use of a basic buffer mixture of sodium carbonate and sodium bicarbonate is advantageous.

The addition of surfactants increases the cleaning activity especially with respect to an increased removal of fat and oil from the dishes.

The addition of e.g. 1 to 2° A) enzymes (especially of enzymes having a high hydrolase activity at pH 8 to 10 and 40 to 50° C.) further increases the cleaning performance in dishwashers. From the commercially available enzymes (company: NOVOZYMES), enzyme preparations having amylase-, lipase- and protease activity bound to a carrier have been used successfully in dishwashing powders.

Further improvements, e.g. for the removal of tea, coffee or rice stains could be achieved by the addition of small amounts (1 to 2%) of Trilon M, a complexing agent which is easily biodegradable, polycarboxylate (Sokalan) and phosphonate (Bayhibit, preferably in amounts of only up to 0.19%).

It has further been shown that the use of a clear rinsing agent is not needed.

Further, the addition of a bleeching agent is not necessary which is especially environmentally friendly.

One further advantage is that the cleaning agents of the present invention exhibit their ideal cleaning activity between 35 and 45° C. This leads to a significant decrease in energy consumption.

Finally, the cleaning agent according to the present invention shows a high storage stability.

One preferred agent, in particular for use as a dishwashing detergent powder, in particular a dishwasher detergent, contains the following components:
Carbamide: 25 to 70% by weight;
electrolyte: 10 to 50% by weight;
surfactants (especially nonionic): 1 to 5% by weight;
enzymes: 1 to 5% by weight;
complexing agent: 1 to 15% by weight;
odorous substances up to 0.1% by weight;

One preferred agent, in particular for use as a hand dishwashing detergent liquid (especially in the form of a concentrate), contains the following components:
carbamide: 10.0 to 20.0% by weight;
amphoteric surfactant(s): 5.0 to 10.0% by weight;
anionic surfactant(s): 5.0 to 20.0% by weight;
electrolytes (e.g. NaCl) 0.1 to 10% (e.g. 1 to 5%) by weight;
stabilizers (e.g., glycerol): 2.0 to 7.0% by weight, e.g., 5.0% by weight;
skin care components: 0.5 to 3.0% by weight, e.g., 2.0% (e.g., proline) by weight;
antimicrobial agents: 0.1 to 1.5% by weight, e.g., 1.0% by (e.g., PHB-esters) weight;
odorous substances/colorants: 0.1 to 1.0% by weight, e.g., 0.5%;
aqueous buffer (e.g. pH 5.4): 35.0 to 70.0% by weight.
(from citric acid/NaOH)

One preferred agent, in particular for use as a sanitary cleaning agent powder contains the following components:
carbamide: 10 to 30% by weight;
electrolytes: 40 to 90% by weight;
surfactants: up to 5% by weight;
complexing agents: up to 20% by weight; and
pH adjusting acids: up to 20% by weight.

In the aforementioned embodiment of the agent for use as a sanitary cleaning agent, the stated surfactant includes one or more particularly advantageously anionic surfactants.

As mentioned above, the present invention not only relates to the use of the agent according to the invention, as a dishwashing detergent or as a sanitary cleaning agent but also a method for reducing or avoiding enzymes through the use of carbamide.

As explained above, the object of the invention is a method for reducing or avoiding enzymes in dishwashing detergents or in sanitary cleaning agents, characterized in that for an enzyme-containing dishwashing detergent or an enzyme-containing sanitary cleaning agent, preferably a certain amount of enzymes is replaced by 5 to 50 times the amount, preferably by 10 to 40 times the amount, more preferred by 15 to 35 times the amount, especially by 20 to 30 times the amount of carbamide or derivatives thereof.

In particular, the method according to the invention is used to replace proteases in part or completely.

According to the inventive method, a person skilled in the art is able to replace the enzyme content of an enzyme-containing cleaning agent for closed systems (in particular of an enzyme-containing agent for cleaning, sanitizing and/or disinfecting), of an enzyme-containing dishwashing detergent or of an enzyme-containing sanitary cleaning agent either in full or in part. If the enzyme-containing starting agent contains, for example, 10 g enzyme, then—with a full replacement—this amount is preferably replaced by 50 g to 500 g carbamide. Due to the changed volume of the substituted substance, adjustments of the other components may be required, e.g., a reduction in the filler content.

The method according to the invention results in a cleaning agent, a sanitary cleaning agent or a dishwashing detergent with a reduced enzyme content or in an enzyme-free cleaning agent.

Thus, an object of the invention is also an enzyme-containing cleaning agent for closed systems, in particular an enzyme-containing agent for cleaning, sanitizing and/or disinfecting, or an enzyme-free cleaning agent, in particular an enzyme free dishwashing detergent or an enzyme-free sanitary cleaning agent that contains 5 to 99.9% by weight, preferably 10 to 95% by weight, more preferred 10 to 90% by weight, even more preferred 20 to 80% by weight, particularly preferred 25 to 75% by weight, very particularly preferred 20 to 70% by weight and especially 20 to 60% by weight carbamide and/or one or more derivates thereof, relative to the total weight of the enzyme-containing or enzyme free cleaning agent for closed systems, the enzyme-free dishwashing detergent or the enzyme-free sanitary cleaning agent.

In summary, it shall be noted that the agent according to the invention constitutes a versatile source for numerous applications due to its unexpectedly advantageous properties. The agent according to the invention exhibits an excellent dissolving power and entrapment capacity for numerous substances. As a neutral, toxicologically harmless natural substance, the main ingredient of the agent according to the invention is very gentle to the skin and quickly biodegradable. It has been found that carbamide is an unexpectedly good solubilizer in particular in cleaning agents for closed systems (in particular in agents for cleaning, sanitizing and/or disinfecting), as well as in dishwashing detergents and sanitary cleaning agents. In spite of the high amounts of carbamide, the agent according to the invention demonstrates to be unexpectedly tolerable by the surfaces to be cleaned, for example dishes and in particular glasses. No undesirable etching effect on the surfaces was observed. In addition and unexpectedly, the agent according to the invention exhibited no unpleasant odors.

On the basis of the toxicologically and ecologically harmless carbamide, the combination with other aforementioned, biologically also harmless additives, allows, for example, also formulations with the claim “bio cleaning agent”.

The invention shall be illustrated based on the following examples.

### EXAMPLES

Two trial series were carried out on the basis of the quality recommendations of the Industrieverband Körperpflege- und Waschmittel e.V. [German Cosmetic, Toiletry, Perfumery and Detergent Association]. Trial series A shows the advantageous properties of the agent according to the invention as a dishwashing detergent, trial series B shows the advantageous properties of the agent according to the invention as a sanitary toilet cleaner.

### Trial Series A: Dishwashing Detergent

### A1: Methods

The dishwashing detergents were tested according to the methods for determining the cleaning power of machine dishwashing detergents, IKW (Industrieverband Körperpflege and Waschmittel e.V.), Frankfurt a.M.; Reprint from SÖFW-Journal, 124. Volume 11/98).

The cleaning power of formulations according to the invention was tested in the following equipment:

Dish washer: Bomann Tisch-Geschirrspüler TSG 704 [Bowman dishwasher TSG 704]

The following parameters were selected:
Program: Fast
Water temperature Wash 49° C./Rinse 55° C.
Program duration+hold time: 60 minutes
Water consumption: 9.6 liters
Dosage detergent: 10 g per rinse cycle
Dosage rinse aid no rinse aid used
Dosage ballast soil: 15 g per rinse cycle

To achieve a better differentiation of the individual test products, a ballast soil was added in the test to the cleaning cycle in addition to the described individual soils. This ballast soil in the form of a deep-frozen soil cube consists primarily of fatty components as well as foods containing proteins and starch. This additional soil was to simulate the soil addition via food rests that is easy to remove and was to put an additional load on the dishwasher.

The various dishes had to undergo a basic cleaning before the individual soils were added. This is necessary in particular because due to the great persistency of some soils, residues from previous trials might still be present on the dishes. Also newly used dishes were to undergo three basic cleanings prior to their first use. The trial soiling was generated as follows:

### 1. Ground Meat on China Plates

225 g ground meat (half/half) and 75 g whole egg mixed together
Stir ground meat/egg mixture (300 g) in 80 ml water and then homogenize with a kitchen mixing rod for 2 min
Weigh 3 g±0.1 g of this mixture onto each plate and distribute evenly
Let dry for 2 h at 70° C. in a drying oven

### Evaluation: Visually According to IKW Photo Catalog after coloration with carbol gentian violet

### 2. Starch Mixture

Preparation for 6 plates:
Dissolve 2.6 g starch mix (potato and corn starch) in 200 ml of water
Heat this 1.3% starch solution for 10 min at 95° C. (cover glass beaker with aluminum foil)
Weigh 29.5 g±0.1 g of this solution onto each plate
Let dry for 4 h at 70° C. in a drying oven
Weigh the plates after drying

### Evaluation

$$\% cleaning power = \frac{mg starch dissolved}{mg starch deposited} \times 100$$

Coloration with iodine (2.5 mM) was done for better visual inspection

### 3. Oat Meal

Preparation for 6 plates:
Boil 25 ml milk (1.5% fat), 75 ml water and 5 g oat meal for 10 min
Distribute 3 g oat meal soup evenly on inner surface of plate
Let dry for 2 h at 70° C. in a drying oven

### Evaluation: Visually According to IKW Photo Catalog after Coloration with Iodine (2.5 mM)

### 4. Egg Yolk

Separate egg yolk from raw eggs
Weigh 1.0 g±0.1 g egg yolk mass into each stainless steel bowl and distribute evenly
Let dry for 30 min at 70° C. in a drying oven
Weigh the plates after drying

### Evaluation

$$\% cleaning power = \frac{mg egg yolk dissolved}{mg egg yolk deposited} \times 100$$

### A2: Assessment

The cleaning power of different formulations was assessed. The higher the point score, the better the cleaning power.

### A3: Formulations

The following solid cleaning formulations were produced:

| Formulation | [% by weight] |
|---|---|
| Carbamide | 50 |
| Sodium sulfate | 15.5 |
| Sodium citrate | 15.5 |
| Span ®80 | 5 |
| Pluriol ® E 4000 | 5 |
| Percarbamide | 2 |
| Sodium carbonate | 5 |
| Limes | 1 |
| Alginate | 1 |

| Formulation | [% by weight] |
|---|---|
| Carbamide | 50 |
| Sodium sulfate | 13 |
| Sodium citrate | 13 |
| Span ®80 | 5 |
| Pluriol ® E 4000 | 5 |
| Percarbamide | 2 |
| Sodium carbonate | 10 |
| Limes | 1 |
| Alginate | 1 |

| Formulation | [% by weight] |
|---|---|
| Carbamide | 50 |
| Sodium sulfate | 16.5 |
| Sodium citrate | 16.5 |
| Span ®80 | 5 |
| Pluriol ® E 4000 | 5 |
| Percarbamide | — |
| Sodium carbonate | 5 |
| Limes | 1 |
| Alginate | 1 |

| Formulation | [% by weight] |
|---|---|
| Carbamide | 50 |
| Sodium sulfate | 16 |
| Sodium citrate | 16 |
| Span ®80 | 5 |
| Pluriol ® E 4000 | 5 |
| Percarbamide | |
| Sodium carbonate | 5 |
| Limes | 1 |
| Alginate | 1 |

| Formulation | [% by weight] |
|---|---|
| Carbamide | 50 |
| Sodium sulfate | 16 |
| Sodium citrate | 16 |
| Marlox ® MO 154 | 5 |
| Pluriol ® E 4000 | 5 |
| Percarbamide | — |
| Sodium carbonate | 5 |
| Limes | 1 |
| Alginate | 1 |
| Enzymes | 1 |

| Formulation | [% by weight] |
|---|---|
| Carbamide | 50 |
| Sodium sulfate | 16.5 |
| Sodium citrate | 16.5 |
| Marlox ® MO 154 | 5 |
| Pluriol ® E 4000 | 5 |
| Percarbamide | — |
| Sodium carbonate | 5 |
| Limes | 1 |
| Alginate | 1 |
| Enzymes | — |

Selected as a reference standard was a commercially available powder dishwashing detergent of a leading manufacturer (containing >30% phosphates, 5-15% acid-based bleaching agents, less than 5% nonionic surfactants, polycarboxylates, enzymes (proteases, amylases).

The following liquid cleaning formulations were produced:

| Formulation | [% by weight] |
|---|---|
| Water | 60.5 |
| Carbamide | 30 |
| Marlox ® MO 154 | 5 |
| Pluriol ® E 4000 | 2 |
| Sodium alginate | 1 |
| Enzymes | 1 |
| Fragrance/color | 0.5 |

| Formulation | [% by weight] |
|---|---|
| Water | 65.5 |
| Carbamide | 25 |
| Marlox ® MO 154 | 5 |
| Pluriol ® E 4000 | 2 |
| Sodium alginate | 1 |
| Enzymes | 1 |
| Fragrance/color | 0.5 |

| Formulation | [% in weight] |
|---|---|
| Water | 60.5 |
| Carbamide | 30 |
| Tween80 | 5 |
| Pluriol ® E 4000 | 2 |
| Sodium alginate | 1 |
| Enzymes | 1 |
| Fragrance/color | 0.5 |

| Formulation | [% by weight] |
|---|---|
| Aqueous buffer (pH 6.4) | 60.5 |
| from citric acid/NaOH | |
| Carbamide | 30 |
| Plurafac ® LF 901 | 5 |
| Pluriol ® E 4000 | 2 |
| Xanthan gum | 1 |
| Enzymes | 1 |
| Fragrance/color | 0.5 |

| Formulation | [% by weight] |
|---|---|
| Aqueous buffer (pH 5.4) | 56.5 |
| from citric acid/NaOH | |
| Carbamide | 15 |
| Marlinat 242/70 | 14 |
| Tego Betaine C 60 | 6 |
| Glycerole 85% | 5 |
| L-proline | 1 |
| Sodium chloride | 2 |
| Limonene | 0.3 |
| Mint oil | 0.1 |
| Kiwifruit green | 0.1 |

With the cleaning agents in liquid form, the formulations A3-7, A3-9, A3-10 and A3-11 were particularly convincing with regard to stability up to 25° C. if 0.1% of PHB-esters are present as preservatives.

### A4: Results

The formulations described in A3 were tested according to the method described in A1 and assessed according to A2. It was found that all recommended formulations fulfill the requirements for a commercially available dishwashing detergent.

The cleaning power of the particularly preferred formulations A3-5 and A3-7 were computed as an example:

| | Examp. | Examp. |
|---|---|---|
| Soiling | A3-5 | A3-7 |
| Ground meat on china plates | 92 ± 7 | 83 ± 11 |
| Oat meal | 88 ± 7 | 77 ± 9 |
| Starch mixture | 99 ± 1 | 95 ± 1 |
| Egg yolk | 98 ± 2 | 96 ± 4 |

It could be demonstrated that the cleaning power of the formulation A3-5 was significantly above the reference standard in all categories (ground meat, oat meal, starch mixture and egg yolk). The formulation A3-7 was also significantly above the reference standard in the categories oat meal, starch mixture and egg yolk.

### A5: Discussion

In summary, it should be stated that the cleaning power of the formulations according to the invention corresponds to and often even surpasses the reference standard. It has also been demonstrated that due to the present invention, enzymes can be reduced significantly or can be omitted entirely.

### Trial Series B: Sanitary Toilet Cleaning Agent

### B1: Methods

On the basis of the quality recommendations of the Industrieverband Körperpflege- und Waschmittel e.V. [German Cosmetic, Toiletry, Perfumery and Detergent Association] (IKW, Department Cleaning Agents and Care Products) a comparable trial method for evaluating the quality of acidic toilet cleaning agents was developed. The sanitary toilet cleaning agents were tested according to the recommendation for the quality evaluation of acidic toilet cleaning agents/quality recommendation of the Industrieverband Körperpflege- und Waschmittel e.V. (IKW), Department Cleaning Agents and Care Products, Frankfurt a.M. (1999 Version).

Examined was the dissolving power of the respective formulations for limestone. The known commercially available product served again as a reference standard.

Before beginning with the trial series, a marble slab had to be crushed using a hammer and a chisel. Care was taken that the respective pieces were as uniform as possible and exhibited a comparable mass (about 13 ±1 g), in order to obtain no deviations during the gravimetric evaluation. Then, the marble pieces were washed thoroughly and dried over night in a drying oven until they reached a constant weight.

For the test, two marble pieces were weighed on an analytical balance such that the total mass was about 25±1 g. Thereafter, they were placed for 15 min into a glass beaker containing 50 g of the test products with the requirement that the pieces were fully covered by the cleaning agent. After the end of this time, the pieces were cleaned thoroughly under running water and then dried until they reached a constant weight in order to be able to determine gravimetrically the dissolved amount of lime.

To be able to compare the test products directly with other products, they were tested as a 20% solution and compared to a 20% reference standard solution.

To determine the limescale dissolving power (LDP) of a product and to improve the statistics, 6 trials were carried out with different marble pieces and a fresh cleaning agent solution each time.

Care was taken that the trials were carried out in a temperature range of 20 to 23° C., i.e., that the temperature of the surroundings, of the products and of the marble carrier were within this temperature range.

### B2: Assessment

The amount of dissolved calcium carbonate was placed in relation to the described standard toilet cleaning agent in a 20% solution.

$$Calculation limestone dissolution index ( L D I ) = \frac{LDP mg test product}{LDP mg standard sanitary toilet cleaner}$$

The limescale dissolution index was to be at least 0.7. In practical applications, it was demonstrated that values above 1.3 were not necessary.

A commercially available sanitary toilet cleaner of a known manufacturer was used as the “standard sanitary toilet cleaning agent”.

### B3: Formulations

| Formulation | [% by weight] |
|---|---|
| Water | 61.5 |
| Carbamide | 25 |
| Citric acid | 10 |
| Marlinat ® 242/70 | 3 |
| Xanthan gum | 0.5 |
| NaCl | — |
| pH value | 2.33 |
| pH value (20% solution) | 2.18 |

| Formulation | [% by weight] |
|---|---|
| Water | — |
| Carbamide | 25 |
| Citric acid | 10 |
| Marlinat ® 242/70 | 3 |
| Xanthan gum | 0.5 |
| NaCl | 61.5 |
| pH value | — |
| pH value (20% solution) | 1.62 |

### B4: Results

| | Lime dissolving power | Lime dissolution index |
|---|---|---|
| Sample name | LDP [mg] | LDI |
| 20% reference standard | 121 ± 7 | 1.00 |
| (pH value: 2.43) | | |
| 20% example B3-1 | 153 ± 14 | 1.27 |
| 20% example B3-2 | 109 ± 6 | 0.90 |

In addition, the formulation B3-1 was tested for its thermal stability. The assessment was visual. At 8° C., 25° C., 30° C. and 40° C., the formulation was clear and liquid.

### B5: Discussion

It was demonstrated that the formulations according to the invention showed an advantageous cleaning effect and at the same time an advantageous stability. It also became apparent that the formulations according to the invention allowed cleaning that was gentle to the surface. The intensive black color of the marble pieces used for the test remained intact.

### C. Further Examples

### C1: Dishwashing detergents

| Formulation | [% in weight] | batch size 7500 g | |
|---|---|---|---|
| Carbamide | 50.0 | 3750.0 | g |
| Genapol EP 2584 | 2.0 | 150.0 | g |
| Lutensol AT 25 | 1.0 | 75.0 | g |
| Sodium carbonate | 15.0 | 1125.0 | g |
| Sodium bicarbonate | 20.12 | 1509.0 | g |
| Tri sodium citrate | 9.0 | 675.0 | g |
| Termamyl 120 T | 0.5 | 37.5 | g |
| Lipolase 100 T | 0.5 | 37.5 | g |
| Savinase 6.0 T | 0.5 | 37.5 | g |
| Bayhibit S | 0.19 | 14.25 | g |
| Carbamide peroxide | 0.19 | 14.25 | g |
| TAED green | 1.0 | 75.0 | g |

| Formulation | [% in weight] | batch size 7500 g | |
|---|---|---|---|
| Carbamide | 50.0 | 3750.0 | g |
| Genapol EP 2584 | 2.0 | 150.0 | g |
| Plurafac LF 901 | 1.0 | 75.0 | g |
| Sodium carbonate | 15.0 | 1125.0 | g |
| Sodium bicarbonate | 20.12 | 1509.0 | g |
| Tri sodium citrate | 9.0 | 675.0 | g |
| Termamyl 120 T | 0.5 | 37.5 | g |
| Lipolase 100 T | 0.5 | 37.5 | g |
| Savinase 6.0 T | 0.5 | 37.5 | g |
| Bayhibit S | 0.19 | 14.25 | g |
| Carbamide peroxide | 0.19 | 14.25 | g |
| TAED green | 1.0 | 75.0 | g |

| Formulation | [% in weight] | batch size 2000 g | |
|---|---|---|---|
| Carbamide | 50.0 | 1000.0 | g |
| Genapol EP 2584 | 2.0 | 40.0 | g |
| Lutensol AT 25 | 1.0 | 20.0 | g |
| Sodium carbonate | 15.0 | 300.0 | g |
| Sodium bicarbonate | 20.12 | 402.4 | g |
| Tri sodium citrate | 9.0 | 180.0 | g |
| Termamyl 120 T | 0.5 | 10.0 | g |
| Lipolase 100 T | 0.5 | 10.0 | g |
| Savinase 6.0 T | 0.5 | 10.0 | |
| Bayhibit S | 0.19 | 3.8 | g |
| Carbamide peroxide | 0.19 | 3.8 | g |
| TAED green | 0.81 | 16.2 | g |

| | | |
|---|---|---|
| Sokalan PA 30 CI | 0.19 | 3.8 |

| Formulation | [% in weight] | batch size 1000 g | |
|---|---|---|---|
| Carbamide | 50.0 | 500.0 | g |
| Genapol EP 2584 | 2.0 | 20.0 | g |
| Plurafac LF 901 | 1.0 | 10.0 | g |
| Sodium carbonate | 15.0 | 150.0 | g |
| Sodium bicarbonate | 20.12 | 201.2 | g |
| Tri sodium citrate | 9.0 | 90.0 | g |
| Termamyl 120 T | 0.5 | 5.0 | g |
| Lipolase 100 T | 0.5 | 5.0 | g |
| Savinase 6.0 T | 0.5 | 5.0 | g |
| Bayhibit S | 0.19 | 1.9 | g |
| Carbamide peroxide | 0.19 | 1.9 | g |
| TAED green | 0.81 | 8.1 | g |

| | | |
|---|---|---|
| Sokalan PA 30 CI | 0.19 | 1.9 |

| Formulation | [% in weight] | batch size 1000 g | |
|---|---|---|---|
| Carbamide | 50.0 | 500.0 | g |
| Genapol EP 2584 | 2.0 | 20.0 | g |
| Lutensol AT 25 | 1.0 | 10.0 | g |
| Sodium carbonate | 15.0 | 150.0 | g |
| Sodium bicarbonate | 21.67 | 216.7 | g |
| Tri sodium citrate | 9.0 | 90.0 | g |
| Bayhibit S | 0.19 | 1.9 | g |
| Carbamide peroxide | 0.19 | 1.9 | g |
| TAED green | 0.81 | 8.1 | g |

| | | |
|---|---|---|
| Sokalan PA 30 CI | 0.19 | 1.9 |

| Formulation | [% in weight] | batch size 2000 g | |
|---|---|---|---|
| Carbamide | 50.0 | 1000.0 | g |
| Genapol EP 2584 | 2.0 | 40.0 | g |
| Lutensol AT 25 | 1.0 | 20.0 | g |
| Sodium carbonate | 14.0 | 280.0 | g |
| Sodium bicarbonate | 20.31 | 406.2 | g |
| Tri sodium citrate | 9.0 | 180.0 | g |
| Termamyl 120 T | 0.5 | 10.0 | g |
| Lipolase 100 T | 0.5 | 10.0 | g |
| Savinase 6.0 T | 1.5 | 30.0 | g |
| Bayhibit S | 0.19 | 3.8 | g |
| TAED green (colorant) | 0.81 | 16.2 | g |
| Sokalan PA 30 CI | 0.19 | 3.8 | g |

| Formulation | [% in weight] |
|---|---|
| Carbamide | 50.0 |
| Tri sodium citrate | 10.0 |
| Plurafac LF 901 | 5.0 |
| Termamyl | 0.75 |
| Lipolase | 0.25 |
| Savinase | 0.5 |
| Sodium sulfate | 27 |
| Sodium chloride | 6.5 |

| Formulation | [% in weight] |
|---|---|
| Carbamide | 50.0 |
| Genapol EP 2584 | 2.0 |
| Lutensol AT 25 | 2.0 |
| Sodium carbonate | 15.0 |
| Sodium bicarbonate | 18.0 |
| Tri sodium citrate | 10.0 |

| Formulation | [% in weight] |
|---|---|
| Carbamide | 50.0 |
| Genapol EP 2584 | 2.0 |
| Lutensol AT 25 | 1.0 |
| Sodium carbonate | 13.5 |
| Sodium bicarbonate | 19.0 |
| Tri sodium citrate | 9.0 |
| Savinase 6.0 T | 0.5 |
| Lipolase 100 T | 0.5 |
| Termamyl 120 T | 1.5 |
| Bayhibit S | 0.19 |
| TAED green | 0.81 |
| Sokalan CP 5 | 1.0 |
| Trilon M | 1.0 |

| Formulation | [% in weight] |
|---|---|
| Carbamide | 45.0 |
| Genapol EP 2584 | 2.0 |
| Lutensol AT 25 | 1.0 |
| Sodium carbonate | 14.5 |
| Sodium bicarbonate | 22.0 |
| Tri sodium citrate | 9.0 |
| Savinase 6.0 T | 0.5 |
| Lipolase 100 T | 0.5 |
| Termamyl 120 T | 1.5 |
| Bayhibit S | 0.19 |
| TAED green | 0.8 |
| Sokalan CP 5 | 1.0 |
| Trilon M | 2.0 |
| lemon perfume oil | 0.01 |

### C2: Sanitary Cleaning Agents

| Formulation | [% in weight] |
|---|---|
| Amidosulfonic acid | 5.0 |
| Citric acid | 14.0 |
| Carbamide | 20.0 |
| Sodium chloride | 51.0 |
| Ufaryl DL 90 C | 1.0 |
| Sodium bicarbonate | 9.0 |

1. Cleaning agent, comprising:
(a) 5 to 99.9% by weight of carbamide;
(b) 5 to 70% by weight of one or more electrolyte(s);
(c) 0.1 to 35% by weight of one or more surfactant(s);
(d) 0.01 to 20% by weight of one or more complexing agent(s).

2. Cleaning agent according to claim 1, comprising 10 to 70% by weight, in particular 20 to 60% by weight of carbamide.

3. Cleaning agent according to claim 1, suitable for use as dishwashing detergent comprising 15 to 65% by weight of carbamide.

4. Cleaning agent according to claim 1, suitable for us as sanitary cleaner comprising 10 to 40% by weight of carbamide.

5. Cleaning agent according to claim 1, comprising 5 to 60% by weight of electrolyte(s), suitable for use as dishwashing detergent.

6. Cleaning agent according to claim 1, comprising up to 10% by weight of one or more enzyme(s).

7. Cleaning agent according to claim 6, comprising 0.01 to 5% by weight of one or more enzyme(s).

8. Cleaning agent according to claim 1, wherein the electrolyte(s) is(are) alkali or earth alkali salts.

9. Cleaning agent according to claim 1, comprising builders, selected from the group consisting of aluminosilicates, zeolites, alginates, polyacrylates, and polyacetales.

10. Cleaning agent according to claim 1, if in liquid form containing water, having a pH-value of 7 to 12, suitable for use as dishwashing detergent.

11. Cleaning agent according to claim 1, if in liquid form containing water, having a pH-value of 1 to 6, suitable for use as sanitary cleaning agent.

12. Cleaning agent according to claim 1, comprising complexing agents selected from nitrilo triacetate (NTA), ethylene diaminotriacetate (TED), ethylene diamine tetraacetate (EDTA), methylglycine diacetate (MGDA).

13. Cleaning agent according to claim 1, comprising one or more stabilizers, in an amount ranging from 0.1 to 5% by weight.

14. Cleaning agent according to claim 13, wherein the stabilizers are selected from the group consisting of glycol, propylene glycol, polyalkylene glycol, and glycerol, sorbitol, mannitol or mixtures thereof.

15. Cleaning agent according to claim 1, present as solid agent in a form selected from the group consisting of particulate form pressed tabs and tablets.

16. Cleaning agent according to claim 1, if present in liquid form, containing water and/or one or more non aqueous solvents.

17. Cleaning agent according to claim 1, suitable for us as a dishwashing detergent, comprising:
(a) 25 to 70% by weight of carbamide;
(b) 10 to 50% by weight of one or more electrolyte(s);
(c) 1 to 5% by weight of one or more surfactant(s);
(d) 1 to 5% by weight of one or more enzyme(s);
(e) 1 to 15% by weight of one or more complexing agent(s); and
(f) up to 0.1% by weight or one or more odorous substances(s);

18. Cleaning agent according to claim 17, comprising a bleaching agent.

19. Use of the cleaning agent according to claim 1 as a dishwashing detergent, as a hand dishwashing detergent, as a laundry detergent for washing machines, for cleaning of textiles, as an agent for cleaning sanitizing and/or disinfecting equipment in the food processing industry and for medical equipment, as a sanitary cleaning agent or as a handcleaner.

20. Use of carbamide as a liquid cleaning agent containing water and/or one or more solvents in the form of a dishwashing detergent, a laundry detergent for washing machines, for cleaning of textiles, and agent for cleaning, sanitizing and/or disinfecting equipment in the food processing industry and for medical equipments, a hand dishwashing deterent, a sanitary cleaning agent or a hand cleaner.
